(19) United States
(12) Patent Application Publication
(10) Pub. No.: US 2025/0135744 A1
(43) Pub. Date: May 1, 2025

(54) COMPOSITE STRUCTURE WITH STEERED FIBRES

(71) Applicant: Airbus Operations Limited, FILTON (GB)

(72) Inventor: Thomas BARNETT, BRISTOL (GB)

(21) Appl. No.: 18/911,377

(22) Filed: Oct. 10, 2024

(30) Foreign Application Priority Data
Oct. 26, 2023 (GB) 2316386.8

(51) Int. Cl. B32B 3/26; B32B 1/00; B32B 5/02; B32B 5/26; B32B 37/16; B32B 38/00; B64C 3/26

(52) U.S. Cl. CPC B32B 3/266; B32B 1/00; B32B 5/02; B32B 5/26; B32B 37/16; B32B 38/0004; B64C 3/26; B32B 2305/076; B32B 2605/18

(57) ABSTRACT

A composite structure comprising a body, such as an aircraft wing skin; and an opening in the body, such as a manhole. The body has steered fiber elements and terminated fiber elements. Each steered fiber element has a curved portion with a plurality of steered fibers which follow curved paths around the opening. The terminated fiber elements alternate with the steered fiber elements, and each terminated fiber element comprises a plurality of terminated fibers which terminate next to the curved portion of a respective steered fiber element.

### CROSS-REFERENCES TO RELATED APPLICATIONS

This application claims the benefit of Great Britain Patent Application Number 2316386.8 filed on Oct. 26, 2023, the entire disclosure of which is incorporated herein by way of reference.

### FIELD OF THE INVENTION

The present invention relates to a composite structure, and a method of manufacturing a comprise structure.

### BACKGROUND OF THE INVENTION

Citation [1] (cited below) examines stress and strain concentrations, using continuous tow steering, around a wingbox access hole. Continuous tow steering around cutouts eliminates fiber cutting, thereby precluding ply-level 3-D stress concentration, which could otherwise lead to delamination-induced damage.

A first problem with Citation [1] is that the thickness of each layer varies around the access hole due to tow overlap.

A second problem with Citation [1] is that the steered shape requires the adjacent tows to tessellate next to it. This would mean this pattern would have to follow either side of the access hole all the way to the forward and aft part of the lower skin. This kink in plies, whilst beneficial around the manhole, would be a stress penalty in the main region of the skin and may undo any benefit.

Citation [2] (cited below) discloses an example of a continuous tow shearing process, which is an advanced tape placement technique with the ability to steer unidirectional prepreg tapes by in-plane shear deformation without the presence of tape buckling, gaps and overlaps.

Citation [1]: Continuous Tow Steering Around an Elliptical Cutout in a Composite Panel; Giovanni Zucco, Mohammad Rouhi, Vincenzo Oliveri, Enzo Cosentino, Ronan M. O'Higgins and Paul M. Weaver; AIAA Journal202159:12, pp.5117-5129; https://doi.org/10.2514/1.J060668.

Citation [2]: Bohao Zhang, Byung Chul Kim, Experimental characterization of large in-plane shear behaviour of unidirectional carbon fibre/epoxy prepreg tapes for continuous tow shearing (CTS) process, Composites Part A: Applied Science and Manufacturing, Volume 162, 2022, 107168, ISSN 1359-835X.

### SUMMARY OF THE INVENTION

A first aspect of the invention provides a composite structure comprising a body and an opening in the body, wherein the body comprises: steered fiber elements, each steered fiber element having a curved portion with a plurality of steered fibers which follow curved paths around the opening; and terminated fiber elements which alternate with the steered fiber elements, wherein each terminated fiber element comprises a plurality of terminated fibers which terminate next to the curved portion of a respective steered fiber element.

Optionally each terminated fiber terminates where it meets the curved portion of a respective steered fiber element.

Optionally the terminated fibers do not follow curved paths around the opening.

Optionally the steered fiber elements comprise: an outer steered fiber element; an inner steered fiber element between the opening and the outer steered fiber element; and one or more intermediate steered fiber elements between the inner and outer steered fiber elements, wherein the curved portions have a progressively increasing average radius of curvature from the inner steered fiber element to the outer steered fiber element.

Optionally at least part of the curved path of at least one of the steered fibers has a radius of curvature less than 100 mm or less than 70 mm or less than 60 mm.

Optionally each steered fiber deviates away from a straight line up to a maximum angle as it passes around the opening, wherein the maximum angle of at least one of the steered fibers is more than 50 degrees or more than 60 degrees.

Optionally the steered fibers and/or the terminated fibers are non-twisted.

Optionally the steered fibers and/or the terminated fibers are carbon fibers.

Optionally the opening is a manhole.

Optionally the composite structure is an aircraft wing skin, and the opening is a manhole in the aircraft wing skin.

Optionally the opening has a rounded shape, such as circular or elliptical.

Optionally each terminated fiber terminates at a cut end.

Optionally at least one of the terminated fiber elements has a greater in-plane width and a greater number of fibers than its respective steered element.

Each steered fiber element has an in-plane width and an out-of-plane thickness. Optionally the out-of-plane thickness of each steered fiber element varies as it follows its curved path around the opening by no more than 50% or by no more than 20% or by no more than 10% or by no more than 5%.

Optionally each curved portion has two points of inflection.

A further aspect of the invention provides a composite structure comprising: a body; and an opening in the body, wherein the body comprises: steered fiber elements which follow curved paths around the opening; and terminated fiber elements, wherein each terminated fiber element terminates where it meets the curved path of a respective steered fiber element.

A further aspect of the invention provides a method of manufacturing a comprise structure according to any preceding aspect, the method comprising: laying the steered fiber elements and the terminated fiber elements, wherein the steered fiber elements are laid along curved paths around the opening; and terminating the terminated fiber elements by cutting.

Optionally the steered fiber elements and the terminated fiber elements are laid one after the other in an alternating sequence.

Optionally each fiber element is laid in a single pass of a deposition head.

Optionally the steered fiber elements and the terminated fiber elements are laid by different passes of the same deposition head.

Optionally the steered fiber elements and the terminated fiber elements are each laid up in prepreg.

A further aspect of the invention provides an aircraft component comprising a composite structure according to any preceding aspect.

Optionally the aircraft component is a wing or a wing skin.

A further aspect of the invention provides an aircraft comprising a composite structure according to any preceding aspect.

### BRIEF DESCRIPTION OF THE DRAWINGS

Embodiments of the invention will now be described with reference to the accompanying drawings, in which:

FIG. 1 shows an aircraft;

FIG. 2 shows a 0 deg layer of a wing skin in the region of a manhole;

FIG. 3 is an enlarged view showing fiber elements of the 0 deg layer of FIG. 2;

FIG. 4 shows a terminated fiber element with an oblique cut end;

FIG. 5 shows a terminated fiber element with a steered tip;

FIG. 6 shows a terminated fiber element which has been laid in two passes;

FIG. 7 shows steered fiber elements which have each been laid in two passes;

FIG. 8 shows a first part of a steered fiber element being laid in a first pass;

FIG. 9 shows a second part of the steered fiber element being laid in a second pass;

FIG. 10 shows a terminated fiber element being laid up;

FIG. 11 shows a terminated fiber element which is wider than the two adjacent steered fiber elements;

FIG. 12 shows a fibrous filler; and

FIG. 13 shows a triangular filler.

### DETAILED DESCRIPTION OF THE PREFERRED EMBODIMENTS

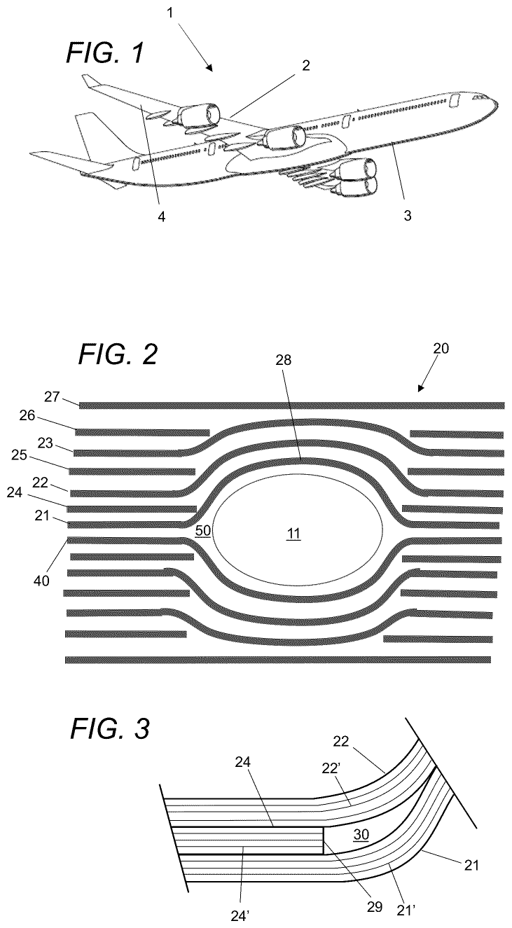

An aircraft 1 shown in FIG. 1 comprises wings 2 and a fuselage 3. Each wing 2 has a composite lower skin 4 and a composite upper skin (not visible in FIG. 1).

The lower skin 4 is formed from a stack of layers of carbon fiber reinforced epoxy resin. The fibers of each layer are typically unidirectional, extending in either a 0 deg direction (generally along the span of the wing), in a 90 deg direction (generally chordwise) or in a 45 deg direction (+/−45 degrees).

The lower skin 4 is provided with a series of manholes, which are large enough to enable access into the interior of the wing for purposes of repair or inspection. Conventionally the carbon fibers run straight, and the wing skin is machined out to form the manhole, leaving fibers that stop and start on either side of the manhole. This reduces the load carrying capability of the wing skin and means that additional weight is required to support the running loads around the manhole.

FIG. 2 is a schematic view of a 0 deg layer 20 of the lower skin 4 in the region of a manhole 11. The manhole 11 is covered by a manhole cover, which may be attached by fasteners to the lower skin 4 around the edge of the manhole 11. The manhole 11 has a rounded shape, in this case elliptical.

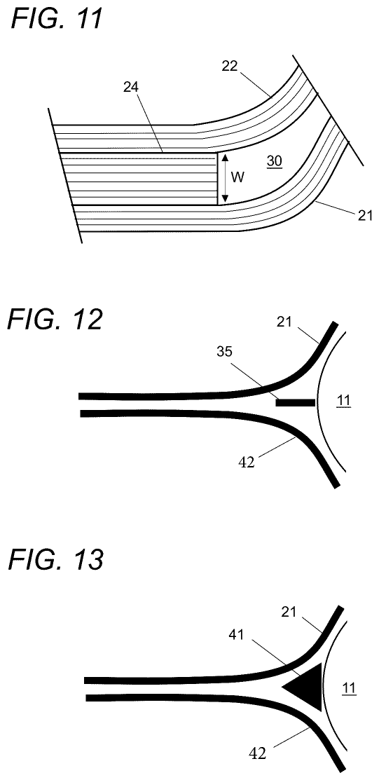

FIG. 2 shows various fiber elements 21-27 in the vicinity of the manhole 11. The fiber elements may be laid down by a deposition head as explained in more detail below. In this example the arrangement of fiber elements is symmetrical so only the fiber elements 21-27 in the top half of the figure are described below—the fiber elements in the bottom half being a mirror image. The fiber elements in the 90 deg layers have a similar symmetrical arrangement, running up and down (in the chordwise direction) in the view of FIG. 2. The fiber elements in the 45 deg layers also have a similar arrangement, running generally at 45 degrees to the fiber elements in FIG. 2. In the case of the 45 deg layers, the arrangement may not have mirror symmetry, as exemplified in FIG. 11 of Citation [1].

The lower wing skin 4 thus provides a composite structure comprising a body (in this case the 0 deg layer 20) and an opening in the body (in this case a manhole 11). The 0 deg layer 20 comprises steered fiber elements 21-23; terminated fiber elements 24-26; and continuous straight elements 27. The terminated fiber elements 24-26 may alternate with the steered fiber elements 21-23.

Each steered fiber element 21-23 has a curved portion with a plurality of steered fibers 21′, 22′ which follow curved paths around the opening 11. For example, the inner steered fiber element 21 closest to the manhole 11 has a curved portion 28, and each other steered fiber element 22, 23 has a similar curved potion, albeit with a progressively reducing degree of curvature.

Each curved portion 28 (and typically also each steered fiber within the curved portion) has two points of inflection as it passes around the opening 11. Optionally each curved portion deviates away from a straight line as it passes around the opening 11, then returns to the straight line after it has passed around the opening 11.

Each fiber element 21-27 comprises a plurality of unidirectional non-twisted carbon fibers, impregnated by an epoxy resin matrix. FIG. 3 is an enlarged view of part of the fiber elements 21, 22, 24. In this example, each fiber element 21, 22, 24 is a tape comprising unidirectional non-twisted carbon fibers 21′, 22′, 24′. These fibers may be grouped with other fibers to form tows, or they may be in any other form. FIG. 3 illustrates the edge of the tape in bold lines, and exemplary fibers 21′, 22′, 24′ in thinner lines. Note that there may be a large number of fibers per tape, and only three fibers are shown per tape in FIG. 3 for illustrative purposes.

In other embodiments of the invention, each fiber element 21-27 may comprise dry fibers (i.e. fibers which are not impregnated by an epoxy resin matrix).

Note that the fiber elements 21-27 are illustrated schematically in FIG. 2, with the lines not touching each other. In practice it is preferred that the adjacent fiber elements abut each other to tessellate the layer 20 with minimal overlaps or voids. FIG. 3 is thus a more realistic representation, although it can also be considered as schematic.

Each steered fiber 21′, 22′ may extend continuously along the full length of the wing skin 4, or at least along the full length of the portion of the wing skin 4 shown in FIG. 2, including the curved portions 28.

Each terminated fiber element 24-26 comprises a plurality of terminated fibers which terminate next to the curved portion of a respective steered fiber element at a cut end. For example, the terminated fiber element 24 shown in FIG. 3 comprises a plurality of terminated fibers 24′ which terminate next to the curved portion 28 of the inner steered fiber element 21 at a cut end 29.

In the example of FIG. 2, each terminated fiber terminates where it meets the curved portion of a respective steered fiber element. For example, each terminated fiber 24′ of the terminated fiber element 24 terminates where it meets the curved portion 28 of the steered fiber element 21 as shown in FIG. 3. Similarly, each terminated fiber of the terminated fiber element 25 terminates where it meets the curved portion of the steered fiber element 22, and so on.

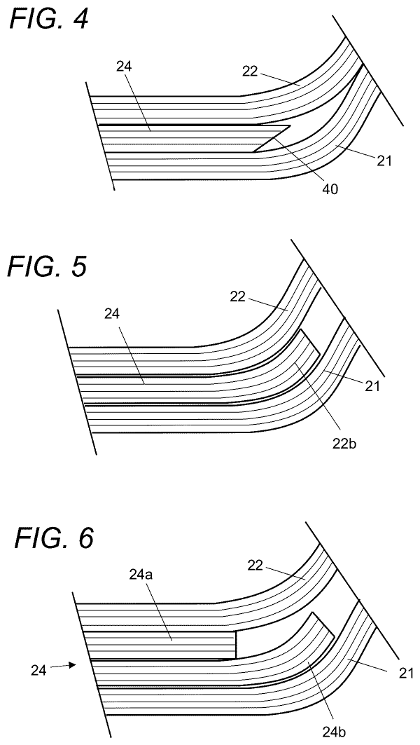

Each termination leaves a void 30 which may become filled with resin during the curing process. One way of reducing the size of the void 30 is to cut the terminated fiber elements at an oblique angle as shown in FIG. 4. In this example, one or all of the terminated fiber elements 24-26 terminates at a face which extends at an oblique angle to a direction of the terminated fibers, an example of such an oblique face 42 being shown in FIG. 4 for the terminated fiber element 24.

In the case of FIG. 4 the terminated fiber element 24 is cut at an oblique angle such that it is longer on the side which the steered fiber elements 21, 22 are steered towards.

In the case of FIG. 4 the oblique face 42 is cut in a straight line, but in other examples the oblique face 42 may be cut along a curved line.

In the example of FIG. 2, the terminated fiber elements 24-26 (and their associated terminated fibers) are substantially straight up to their cut ends, and do not follow curved paths around the opening 11. In the alternative example of FIG. 5, a modified terminated fiber element 24 is shown with a curved tip 22b which curves slightly before terminating next to the curved portion 28 of the steered fiber element 21.

Hence in FIG. 5 the terminated fibers 24′ do not terminate at the point where they meet the curved portion 28 of the steered fiber element 21 as in FIG. 3, but rather they follow the path of the curved portion 28 for a small distance before terminating.

In the case of FIG. 5, the curved tip 22b is terminated at a cut end where the cut is perpendicular to a direction of the terminated fibers. In other embodiments the curved tip 22b may be cut at an oblique angle similar to the oblique face 42 of FIG. 4.

Each fiber element 21-27 may be laid in a single pass of a deposition head, or in multiple passes of a deposition head. FIG. 6 gives an example of a terminated fiber element 24 which is laid in two passes: a first pass which deposits a first collection of terminated fibers 24a which terminate next to the curved portion 28 of the steered fiber element 21 without following a curved path around the opening; and a second pass which deposits a second collection of terminated fibers 24b with a curved tip. The curved tip curves slightly before terminating next to the curved portion 28 of the steered fiber element 21.

The terminated fiber element 24 in FIG. 6 has twice the width of the terminated fiber element 24 in FIG. 5, but in other embodiments the collections of terminated fibers 24a, 24b may be half-width so the overall width of the terminated fiber element is the same.

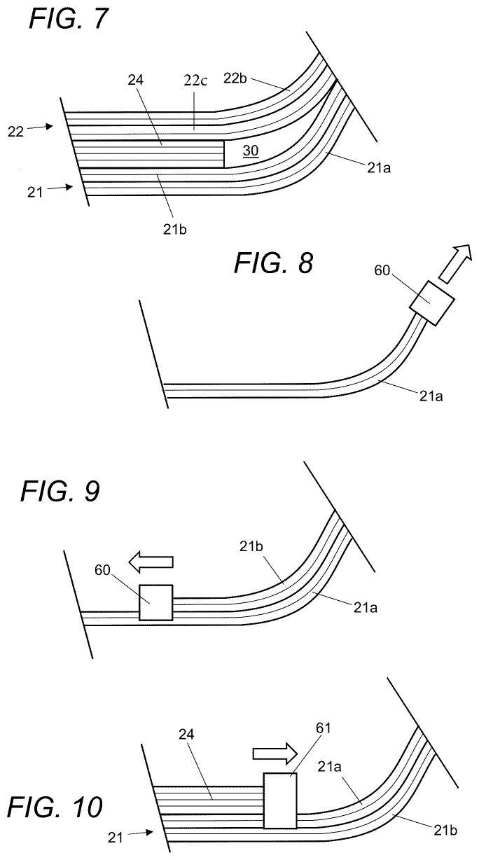

FIGS. 7-10 give an example of how the steered fiber elements 21, 22 could be laid in two passes. In a first pass, shown in FIG. 8, a deposition head 60 lays a first strip 21a of steered fibers. In a second pass, shown in FIG. 9, the deposition head 60 lays a second strip 21b of steered fibers next to the first strip. The pair of adjacent strips together provide a single steered fiber element 21 shown in FIG. 7. The steered fiber element 22 is laid up in a similar way from two adjacent strips 22a, 22c as shown in FIG. 7.

In FIG. 10, the terminated fiber element 24 is laid by a different (wider) deposition head 61 which can deposit the terminated fiber element 24 in a single pass.

FIG. 11 gives an example in which the terminated fiber element 24 has a greater in-plane width W (and hence a greater number of fibers) than its respective steered element 21. This increased width W may be achieved by using a wider deposition head, or by depositing the terminated fiber element 24 in multiple passes.

The reverse of FIG. 11 is also possible: i.e. the terminated fiber element 24 may have a lower in-plane width W (and hence a smaller number of fibers) than its respective steered element 21.

Returning to FIG. 2: the steered fiber elements 21-23 comprise an outer steered fiber element 23; an inner steered fiber element 21 between the opening 11 and the outer steered fiber element 23; and an intermediate steered fiber element 22 between the inner and outer steered fiber elements. In this case there is only a single intermediate steered fiber element 22, but in other embodiments there may be more than one.

The curved portions 28 have a progressively increasing average radius of curvature from the inner steered fiber element 21 to the outer steered fiber element 23. In other words, the curved portions 28 become progressively less curved. This enables the next fiber element to be a continuous straight element 27 which passes the manhole 11 without needing to deviate in any way. Hence the pattern of steered fiber elements 21-23 does not need to follow either side of the manhole 11 all the way to the forward and aft part of the lower skin 4.

At least part of the curved path of at least one of the steered fibers may have a radius of curvature less than 100 mm or less than 70 mm or less than 60 mm. For example, the steered fibers 21′ of the inner steered fiber element 21 may have such a low radius of curvature in the highly curved region shown in FIG. 3.

A low radius of curvature is particularly important for the inner steered fiber element 21 because it will reduce the size of the triangular void 50 shown in FIG. 2 at the edge of the manhole 11 between the inner steered fiber element 21 and the adjacent steered fiber element 40 on the other half of the manhole.

Optionally the triangular void 50 could be filled with a fibrous filler element 35 shown in FIG. 12, or a triangular filler 41 shown in FIG. 13.

The curved paths of the steered fibers each deviate away from a straight line up to a maximum angle as they pass around the manhole 11. The maximum angle of at least one of the curved paths may be more than 50 degrees or more than 60 degrees. For example, the steered fibers 21′ of the inner steered fiber element 21 may have a maximum angle of more than 60 degrees in the highly curved region shown in FIG. 3.

As noted above, the steered fiber elements 21-23 are laid along curved paths around the opening 11, and the terminated fiber elements 24-26 are terminated (typically by cutting). Different deposition methods will now be described.

In the examples below the fiber elements 21-27 are each laid up in prepreg (i.e., fibers impregnated with an uncured or partially cured matrix material such as an epoxy resin) but in other embodiments some (or all) of the fiber elements 21-27 may be laid up as dry fiber.

Laying up a wide prepreg tape (e.g. 1 or 2 inch wide) along a path with in-plane curvature (as in FIG. 2) can cause fibers on the inside of the curve to buckle. One solution to this problem is to use a continuous tow shearing process as described in Citation [2]. Each steered fiber element has an in-plane width and an out-of-plane thickness. A problem with continuous tow shearing processes is that they may cause the out-of-plane thickness of the steered fiber element to vary as it follows its curved path around the opening. Such variation is undesirable because it means that different length fasteners may be required around the periphery of the opening, and in the case of a manhole cover or window it can cause difficulties in providing a tight seal between the window/manhole cover and the structure.

Preferably the out-of-plane thickness of each steered fiber element 21-23 varies as it follows its curved path around the manhole 11 by no more than 50% or by no more than 20% or by no more than 10% or by no more than 5%.

Hence it may be preferred to use a more traditional “fiber placement” approach in which a relatively narrow tape of prepreg fibers (for instance 6 mm wide or narrower) is used to form at least the steered fiber elements 21-23. This reduces the risk of buckling and reduces variation of out-of-plane thickness, in return for a slower deposition rate. In continuous tow shearing there may be a change of thickness of the layer, but in tow steering the thickness of the layer remains unchanged but it may buckle to create wrinkles in the layer. Preferably any wrinkles in a layer are no more than 5% of the thickness of the layer.

If the tape is very narrow, then optionally each steered fiber element could be laid in a series of passes, as in FIGS. 8 and 9, to make the steered fiber element wider.

At the deposition head, the prepreg tape may be unrolled and applied with heat and pressure. An example of a suitable deposition head is given in FIG. 1(a) of Citation [2], in which the deposition head has a tape guide roller, compaction shoe and gripping shoe. Other types of deposition head are well known to a skilled person so will not be described in detail here. The deposition head may incorporate a blade to cut the terminated fiber elements at a required angle—for instance at a right angle as in FIGS. 3 and 5 or at an oblique angle as in FIG. 4.

The steered fiber elements 21-23 and the terminated fiber elements 24-26 could have the same widths, or different widths. For example, each terminated fiber element 24-26 could be laid as a single pass of a 2 inch wide tape from a wide deposition head 61 as in FIG. 10, and each steered fiber element 21-23 could be laid as two passes of 6 mm wide strips from a narrow deposition head 60 as in FIGS. 8 and 9 (giving a total thickness of 12 mm per steered fiber element). Alternatively, the steered fiber elements 21-23 and the terminated fiber elements 24-25 may be laid by different passes of the same deposition head.

Optionally the steered fiber elements 21-23 are laid before any of the terminated fiber elements 24-26 are laid. More typically the fiber elements 21-26 are laid one after the other in an alternating sequence: 21, 24, 22, 25, 23, 26, 27 etc.

Typically the terminated fiber elements on opposite sides of the manhole 11 are laid up in the same pass of a deposition head. For example, the terminated fiber element 24 on the left side of the manhole may be laid up in the same pass as the opposite terminated fiber element on the right side of the manhole 11. After this pair of terminated fiber elements has been deposited from left to right, the deposition head may deposit the next steered fiber element 22 from right to left, and so on.

The fiber elements 21-27 are typically each laid up in prepreg, although they may be laid up as dry fibers and subsequently impregnated (for instance by resin infusion). Once all layers of the wing skin 4 have been laid up, the wing skin is cured under heat and pressure to cure the epoxy resin matrix and provide the finished composite structure.

The present invention is particularly useful for a manhole in an aircraft wing skin, as described in FIGS. 1-13, because aircraft wing skins are exposed to high load in flight and the skin thickness at the edge of the manhole should be tightly controlled so as to avoid variations in the aerodynamic surface of the wing which might increase drag. However, in other embodiments of the present invention the opening may be an opening for a window in the fuselage 3, a cut-out in a composite wing rib within the wing 2, or an opening in any other composite structure of an aircraft, a ship, or any other article.

In summary, the embodiments described above provide a composite structure comprising a body 20 and an opening 11 in the body. The body 20 comprises steered fiber elements 21-23 which follow curved paths around the opening 11 and terminated fiber elements 24-26. Each terminated fiber element 24-28 terminates next to the curved path 28 of a respective steered fiber element.

In step 1, the fibers closest to the center of the manhole 11 are steered around the manhole 11. In step 2, the next fibers to be laid down run straight until they hit the steered fibers. At this point they are terminated. In step 3, the next steered fibers laid down follow the same pattern, but at a slightly shallower angle around the manhole 11 due to the offset provided by the terminated fibers. In step 4, another straight fiber is laid outside of that in step 3, and this terminates once it hits the steered fibers of step 3. The above pattern is then repeated, getting further away from the center of the manhole 11 each time. As this goes further, the angle of the fibers steered around the manhole 11 reduces until they are almost straight. At this point a continuous straight fiber element 27 runs all the way along the outside. From this continuous straight fiber element 27, any subsequent fibers laid down in the majority of the wing skin 4 are now straight.

The main benefit is the weight saving coming from the optimization of the fibers to the shapes required. Another benefit is that it reduces wastage as fibers are not laid down across the manhole 11 that are then machined out and thrown away.

Tow steering has a low deposition rate but a high degree of optimization capability. Conventional automated tape laying is the opposite. The present invention allows these two methods to be used alongside each other, providing a highly optimized design around manholes, or other openings, and a higher deposition rate in the main section of the wing skin.

Where the word ‘or’ appears this is to be construed to mean ‘and/or’ such that items referred to are not necessarily mutually exclusive and may be used in any appropriate combination.

Although the invention has been described above with reference to one or more preferred embodiments, it will be appreciated that various changes or modifications may be made without departing from the scope of the invention as defined in the appended claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A composite structure comprising:
a body and an opening in the body, wherein the body comprises:
steered fiber elements, each steered fiber element having a curved portion with a plurality of steered fibers which follow curved paths around the opening; and
terminated fiber elements which alternate with the steered fiber elements, wherein each terminated fiber element comprises a plurality of terminated fibers which terminate next to the curved portion of a respective steered fiber element.

2. The composite structure according to claim 1, wherein each terminated fiber terminates where said terminated fiber meets the curved portion of a respective steered fiber element.

3. The composite structure according to claim 1, wherein the terminated fibers do not follow curved paths around the opening.

4. The composite structure according to claim 3, wherein the steered fiber elements comprise:
an outer steered fiber element;
an inner steered fiber element between the opening and the outer steered fiber element; and
one or more intermediate steered fiber elements between the inner steered fiber element and the outer steered fiber element, wherein the curved portions have a progressively increasing average radius of curvature from the inner steered fiber element to the outer steered fiber element.

5. The composite structure according to claim 1, wherein at least part of a curved path of at least one of the steered fibers has a radius of curvature less than 100 mm, or less than 70 mm, or less than 60 mm.

6. The composite structure according to claim 1, wherein each steered fiber deviates away from a straight line up to a maximum angle as said steered fiber passes around the opening, wherein a maximum angle of at least one of the steered fibers is more than 50 degrees, or more than 60 degrees.

7. The composite structure according to claim 1, wherein the steered fibers, the terminated fibers, or both are non-twisted.

8. The composite structure according to claim 1, wherein the opening is a manhole, and
wherein the composite structure is an aircraft wing skin, and the manhole is in the aircraft wing skin.

9. The composite structure according to claim 1, wherein each terminated fiber terminates at a cut end.

10. The composite structure according to claim 1, wherein at least one of the terminated fiber elements has a greater in-plane width and a greater number of fibers than a respective steered element.

11. The composite structure according to claim 1, wherein each steered fiber element has an in-plane width and an out-of-plane thickness, and
wherein the out-of-plane thickness of each steered fiber element varies along a curved path around the opening by no more than 50%, or by no more than 20%, or by no more than 10%, or by no more than 5%.

12. The composite structure according to claim 1, wherein each curved portion has two points of inflection.

13. A composite structure comprising:
a body; and
an opening in the body,
wherein the body comprises:
steered fiber elements which follow curved paths around the opening; and
terminated fiber elements, wherein each terminated fiber element terminates where said terminated fiber element meets a curved path of a respective steered fiber element.

14. A method of manufacturing the comprise structure according to claim 1, the method comprising:
laying the steered fiber elements and the terminated fiber elements, wherein the steered fiber elements are laid along curved paths around the opening; and
terminating the terminated fiber elements by cutting.

15. The method according to claim 14, wherein the steered fiber elements and the terminated fiber elements are laid one after the other in an alternating sequence.

16. The method according to claim 14, wherein each fiber element is laid in a single pass of a deposition head.

17. The method according to claim 14, wherein the steered fiber elements and the terminated fiber elements are laid by different passes of the same deposition head.

18. The method according to claim 14, wherein the steered fiber elements and the terminated fiber elements are each laid up in prepreg.

19. An aircraft component comprising:
the composite structure according to claim 1.

20. An aircraft comprising:
the composite structure according to claim 1.
